(19) United States
(12) Patent Application Publication
(10) Pub. No.: US 2015/0118554 A1
(43) Pub. Date: Apr. 30, 2015

(54) GRAPHENE-CONTAINING ELECTROCHEMICAL DEVICE

(71) Applicant: Enerage Inc., Wujie Township (TW)

(72) Inventors: Mark Y. Wu, Wujie Township (TW); Cheng-Yu Hsieh, Wujie Township (TW); Jing-Ru Chen, Wujie Township (TW); Shu-Ling Hsieh, Wujie Township (TW)

(73) Assignee: Enerage Inc., Wujie Township (TW)

(21) Appl. No.: 14/108,950

(22) Filed: Dec. 17, 2013

(30) Foreign Application Priority Data
Oct. 28, 2013 (TW) 102138923

(51) Int. Cl. H01G 9/042; H01M 4/66; H01M 4/62

(52) U.S. Cl. CPC H01G 9/042; H01G 9/0425; H01M 4/623; H01M 4/625; H01M 4/661; H01M 4/133
USPC 429/217; 361/528

(57) ABSTRACT

A graphene-containing electrochemical device includes cathode/anode current collectors, cathode/anode active layers and a separator. The cathode/anode active layers are formed on the cathode/anode current collectors, and include a metal foil substrate and a graphene conductive layer. The graphene conductive layer includes several first graphene sheets and the polymer binder used to bind the first graphene sheets. The cathode/anode active layers include several second graphene sheets and cathode/anode active particles. The second graphene sheets and the cathode/anode active particles are bound by the polymer binder and further adhered to the graphene conductive layer. The second graphene sheets are blended among the cathode/anode active particles. The graphene conductive layer is employed to increase the compatibility between the cathode/anode active material and the metal foil substrate, and to reduce the junction resistance, thereby forming an integrated conductive network and improving the performance of the elements in the device.

### CROSS-REFERENCE TO RELATED APPLICATION

This application claims the priority of Taiwanese patent application No. 102138923, filed on Oct. 28, 2013, which is incorporated herewith by reference.

### BACKGROUND OF THE INVENTION

1. Field of the Invention

The present invention generally relates to an electrochemical device, and more specifically to an electrochemical device containing graphene.

2. the Prior Arts

Graphene, that is, monolayer graphite, has a unique lattice structure composed of a monolayer of carbon atoms bound by sp2 chemical bond and closely packed so as to form a two dimensional honeycomb shape. Graphene thus has a thickness of only one carbon atom. It is believed that the graphitic bond is a hybrid chemical bond combining the covalent bond and the metallic bond. Therefore, graphene is a perfect combination of the electrical insulator and the electrical conductor. The winners of the Nobel Prize in Physics for 2010, Andre Geim and Konstantin Novoselov successfully obtained graphene by peeling a piece of graphite with adhesive tape at University of Manchester in UK in 2004.

Graphene is the thinnest and hardest material in the world. Its thermal conductivity is greater than that of carbon nanotube and diamond, and its electron mobility at room temperature is higher than that of the carbon nanotube and silicon crystal. Additionally, the electric resistivity of graphene is even lower than that of copper or silver. So far, graphene is considered as the material with the lowest resistivity. Those unique electrical and mechanical properties allow the composite material added with graphene to provide various functions not only with excellent mechanical and electrical performance, but also superior processability so as to greatly expand the application field of the composite material. Specifically, graphene is a two dimensional crystal bound by benzene-ring chemical bond, which is chemically stable with inert surfaces. Thus, its interaction with other medium (like solvents) is weak. Pieces of graphene are easily congregated because of strong Van Der Waals forces between thereof such that graphene sheets are difficult to dissolve in water and commonly used organic solvents. In particular, it is not easy to thoroughly blend graphene with other materials to form composite material. Graphene is therefore greatly limited in further research and actual application. For now, traditional composite materials are formed of other graphitic materials or carbon materials.

US patent publication No. 2009/0,325,071 disclosed “Intercalation Electrode Based on Ordered Graphene Planes”, in which an electrochemical cell including a current collector, an anode and graphene planar layers with lithium is intercalated. Specifically, the electrochemical cell includes the cathode, the anode and the electrolyte. The anode of the electrochemical device uses the metal foil (such as copper, nickel or stainless steel) as the substrate for the current collector, and the graphene layer is formed on the metal foil by CVD (chemical vapor deposition) such that the anode current collector is manufactured. The thickness of the metal foil in this patent is 10 nm-10 μm. The processing temperature of the CVD is 300˜600° C.

US patent publication No. 2013/0,095,389 disclosed “GRAPHENE CURRENT COLLECTORS IN BATTERIES FOR PORTABLE ELECTRONIC DEVICES”, in which an electrochemical device, that is, a battery cell, includes a cathode current collector including graphene, a cathode active material, an electrolyte, an anode active material and an anode current collector including graphene. The anode current collector includes a substrate made of aluminum foil with a thickness of 15 μm. The substrate of the cathode current collector is a copper foil with a thickness of 10 μm. This patent utilizes the spraying process to spray the graphene onto the metal foil so as to form a graphene layer with a thickness of 1 μm. Then the anode/cathode active material are coated on the graphene layers of the anode/cathode current collectors, respectively. It is also emphasized that the graphene on the current collectors may reduce the manufacturing cost and/or may increase the energy density of the battery cell.

It is obvious the focus in the prior arts is the enhancement of the electrical conductivity of the current collector by adding the graphene layers. However, one of the primary bottlenecks is the poor performance of conductivity of the anode/cathode materials. Another problem is the incompatibility between the different adjacent layers, leading to high junction resistance and deteriorating the electrochemical performance. Therefore, it is greatly desired to provide a graphene-containing electrochemical device so as to overcome the problems in the prior arts.

### SUMMARY OF THE INVENTION

The primary objective of the present invention is to provide a graphene-containing electrochemical device for serving as the precursor of the battery/capacitor and including a cathode current collector, a cathode active layer, an anode current collector, an anode active layer and a separator. The cathode/anode active layers are formed on the cathode/anode current collectors, respectively, oppositely provided and separated by the separator. Each of the cathode/anode current collectors has a metal foil substrate and a graphene conductive layer. The graphene conductive layer includes a plurality of graphene sheets and a polymer binder used to bind the graphene sheets onto the metal foil substrate.

The cathode/anode active layers include a plurality of second graphene sheets and a plurality of cathode/anode active particles, which are adhered onto the graphene conductive layer by the polymer binder. The second graphene sheets are blended among the cathode/anode active particles.

Therefore, the conductivity of the cathode/anode active particles is not only increased with the graphene added to the graphene-containing electrochemical device, but the compatibility between the cathode/anode active material and the metal foil substrate is also increased and the junction resistance is reduced because the current collector has the graphene layer, so as to form an integrated conductive network, thereby greatly improving the performance of the elements of the electrochemical device.

### BRIEF DESCRIPTION OF THE DRAWINGS

The present invention can be understood in more detail by reading the subsequent detailed description in conjunction with the examples and references made to the accompanying drawings, wherein:

FIG. 1 is a cross-sectional view showing a graphene-containing electrochemical device according to one embodiment of the present invention;

FIG. 2 is a cross-sectional view showing a cathode/anode current collector employed in the electrochemical device of the present invention;

FIG. 3 is a top view showing the first/second graphene conductive layers employed in the electrochemical device of the present invention; and

FIG. 4 is a top view showing the cathode/anode active layer employed in the electrochemical device of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

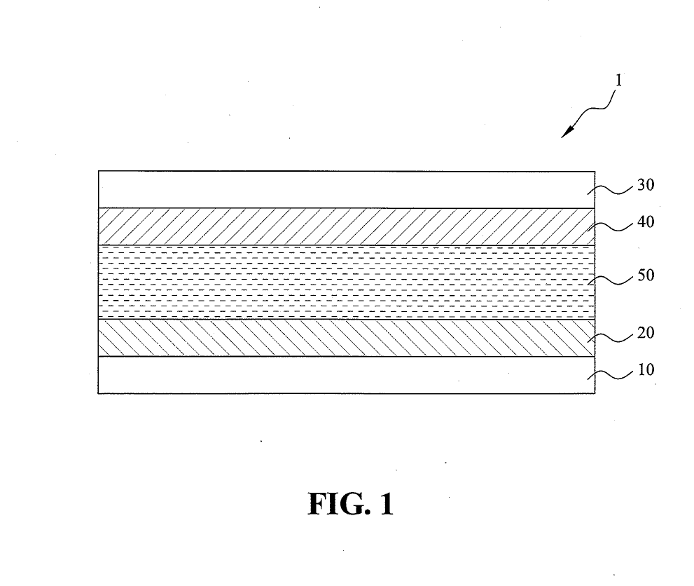

FIG. 1 is a cross-sectional view showing a graphene-containing electrochemical device according to one embodiment of the present invention. As shown in FIG. 1, the graphene-containing electrochemical device 1 of the present invention includes a cathode current collector 10, a cathode active layer 20, an anode current collector 30, an anode active layer 40 and a separator 50. The cathode active layer 20 is stacked on the cathode current collector 10, the separator 50 is stacked on the cathode active layer 20, and the anode active layer 40 is stacked on the separator 50. As for the whole device, the cathode current collector 10 and the cathode active layer 20 are mirror symmetrically configured with respect to the anode current collector 30 and the anode active layer 40 by the separator 50.

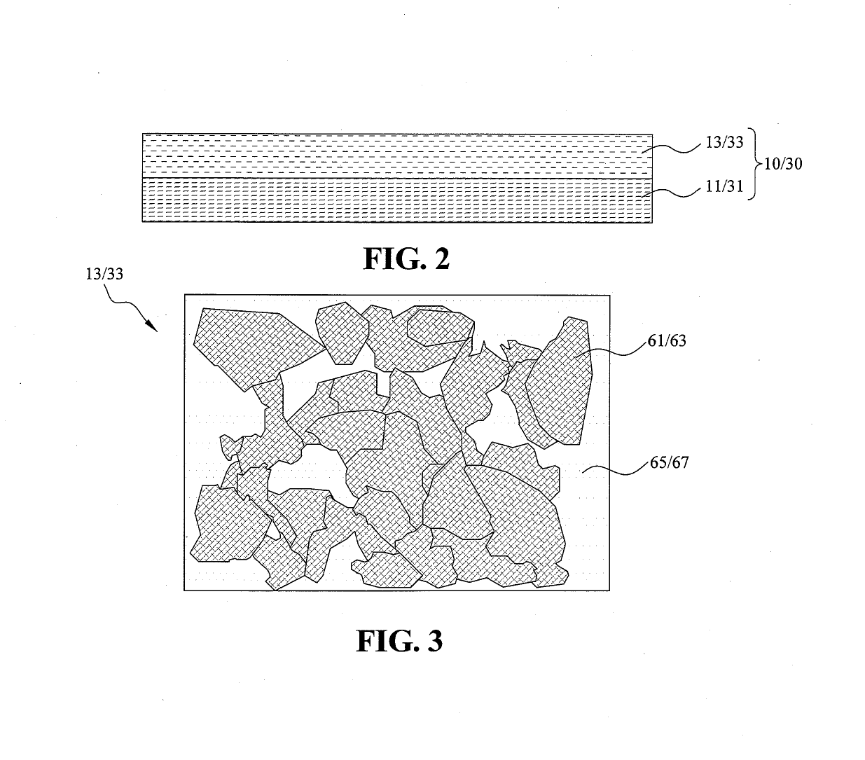

FIG. 2 is a cross-sectional view showing the cathode/anode current collector employed in the electrochemical device of the present invention As shown in FIG. 2, the cathode current collector 10 of the graphene-containing electrochemical device 1 of the present invention includes a first metal foil substrate 11 and a first graphene conductive layer 13 stacked on the first metal foil substrate 11, and the anode current collector 30 includes a second metal foil substrate 31 and a second graphene conductive layer 33 stacked on the second metal foil substrate 31. Specifically, the first graphene conductive layer 13 faces the surface of the second graphene conductive layer 33. In other words, the second metal foil substrate 31 and the second graphene conductive layer 33 are arranged in reverse order with respect to the configuration of the first metal foil substrate 11 and the first graphene conductive layer 13. Each of the first graphene conductive layer 13 and the second graphene conductive layer 33 has a thickness less than 5 μm. FIG. 3 is a top view showing the first/second graphene conductive layers employed in the electrochemical device of the present invention As shown in FIG. 3, the first graphene conductive layer 13 includes a plurality of first graphene sheets 61 and a first polymer binder 65, and the second graphene conductive layer 33 includes a plurality of second graphene sheets 63 and a second polymer binder 67. Also referring to FIG. 2, the first graphene sheets 61 are bound together and adhered onto the surface of the first metal foil substrate 11 by the first polymer binder 65. Similarly, the second graphene sheets 63 are bound together and adhered onto the surface of the second metal foil substrate 13 by the second polymer binder 67. Each of the first graphene sheets 61 and the second graphene sheets 63 has a shape of thin flake, and a thickness of 1˜50 nm with a planar lateral dimension of 1 μm˜50 μm. The thickness of the first polymer binder 65 is larger than thickness of the first graphene sheets 61, and the thickness of the second polymer binder 67 is larger than thickness of the second graphene sheets 63.

The first metal foil substrate 11 and the second metal foil substrate 31 are metal foils made of at least one of aluminum, copper, titanium, nickel, cobalt, manganese and stainless steel. The first polymer binder 65 and/or the second polymer binder 67 is selected from a group including at least one of polyvinylidene fluoride, polyethylene terephthalate, polyurethane, polyethylene oxide, polyacrylonitrile, polyacrylamide, poly(methyl acrylate), polymethyl methacrylate, polyvinyl acetate, polyvinyl pyrrolidone, polytetraglycol Diacrylate, polyimide, cellulose acetate, cellulose acetate butyrate, cellulose acetate propionate, ethyl cellulose ethoce, cyano ethyl cellulose, cyano ethyl polyvinyl alcohol and carboxy methyl cellulose. More specifically, the first polymer binder 65 and/or the second polymer binder 67 in contact with an electrolyte show a colloidal state. Furthermore, each of the first polymer binder 65 and the second polymer binder 67 includes at least one of a thermosetting resin and a photo-setting resin, and the thermosetting resin or the photo-setting resin includes at least one of epoxy resin and phenolic resin. As a result, the adhesion between the first metal foil substrate 11 and the first graphene conductive layer 13 is enhanced, and similarly, the adhesion between the second metal foil substrate 31 and the second graphene conductive layer 33 is also improved.

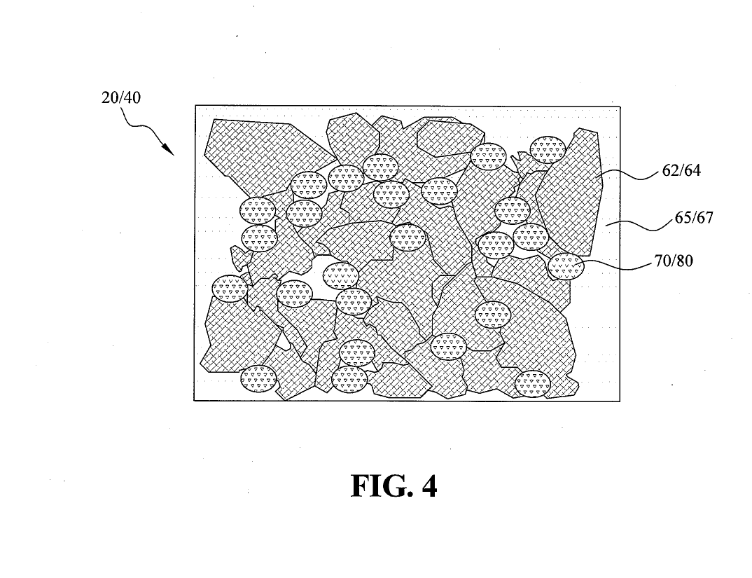

FIG. 4 is a top view showing the cathode/anode active layer employed in the electrochemical device of the present invention. As shown in FIG. 4, the cathode active layer 20 includes a plurality of third graphene sheets 62 and a plurality of cathode active particles 70, which are bound and adhered onto the first graphene conductive layer 13 by the first polymer binder 65. The first polymer binder 65 may naturally spill from the first graphene conductive layer 13, or alternatively the first polymer binder 65 is forced to spill by imposing additional force onto the surface of the first graphene conductive layer 13 such that the third graphene sheets 62 are blended among the cathode active particles 70, and have a thickness of 1˜50 nm with a planar lateral dimension of 1 μm˜50 μm. The cathode active particles 70 are a lithium metal compound, a metal oxide or active carbon, and the metal oxide includes at least one of manganese oxide and ruthenium oxide. The third graphene sheets 62 are less than 10 wt % with respect to the cathode active particles 70.

Similarly, it is preferred that the anode active layer 40 includes a plurality of fourth graphene sheets 64 and a plurality of anode active particles 80, which are bound and adhered onto the second graphene conductive layer 33 by the second polymer binder 67. The second polymer binder 67 may naturally spill from the second graphene conductive layer 33, or alternatively the second polymer binder 67 is forced to spill by imposing additional force onto the surface of the second graphene conductive layer 33 such that the fourth graphene sheets 64 are blended among the anode active particles 80, and have a thickness of 1˜50 nm with a planar lateral dimension of 1 μm˜50 μm. The anode active particles 80 are at least one of graphite, mesocarbon microbead (MCMB), silicon, tin oxide, and active carbon. The fourth graphene sheets 64 are less than 50 wt % with respect to the anode active particles 80.

The separator 50 is provided between the anode active layer 40 and the cathode active layer 20, and is used as the separator in electrochemical device. Preferably, the separator 50 includes at least one of polyethylene, polypropylene, nonwoven fabric and specific paper.

To clearly explain the graphene-containing electrochemical device and the method of manufacturing the same, some practical examples are described in detail hereinafter. However, it should be noted that the examples are only illustrative and not intended to limit the scope the present invention.

### Example 1

The graphene sheets are placed into N-methyl pyrrolidinone (NMP) as a solvent. PVDF (polyvinylidene fluoride) as the polymer binder is then added to form a primitive slurry, which is ground by a ball mill for hours to form the graphene slurry. The graphene slurry is sprayed on the metal aluminum foil and dried to evaporate NMP so as to form the cathode/anode current collectors. Next, 80 wt % of the active carbon as the cathode material, 10 wt % of the graphene powder and 10 wt % of the polymer binder are added to the NMP solvent to prepare the slurry mixture, which is then ball milled to form the cathode slurry for the cathode material. 80 wt % of the active carbon as the anode material, 10 wt % of the graphene powder and 10 wt % of the polymer binder are added to the NMP solvent, and then the mixture is ball milled to form the anode slurry for the anode material. The cathode slurry and the anode slurry are coated on the cathode current collector and the anode current collector, respectively, and dried in the vacuum oven to form the cathode active layer and the anode active layer. The separator is sandwiched between the cathode active layer and the anode active layer so as to form the graphene-containing electrochemical device substantially composed of the first metal foil substrate, the first graphene conductive layer, the cathode active layer, the separator, the anode active layer, the second graphene conductive layer and the second metal foil substrate, which are sequentially configured. It should be noted that the first metal foil substrate and the first graphene conductive layer are included in the cathode current collector, and the second graphene conductive layer and the second metal foil substrate are included in the anode current collector. Furthermore, the electrolyte is injected into the graphene-containing electrochemical device to form a simple capacitor device. One advantage of the simple capacitor device over the traditional capacitor is that the impedance is reduced by about 70%.

### Example 2

The graphene sheets are placed into N-methyl pyrrolidinone (NMP) as a solvent, and then PVDF (polyvinylidene fluoride) as the polymer binder is added and mixed to form a primitive slurry, which is ground by a ball mill for hours to form the graphene slurry. The graphene slurry is sprayed onto the metal aluminum foil and dried to evaporate NMP so as to form the cathode/anode current collectors. Next, 80 wt % of the active carbon as the cathode material, 10 wt % of the graphene powder and 10 wt % of the polymer binder are added to the NMP solvent with 50 wt % of the graphene sheets, and ball milled for thorough mixing to form the cathode slurry for the cathode material. 80 wt % of the active carbon as the anode material, 10 wt % of the graphene powder and 10 wt % of the polymer binder are added to the NMP solvent with 50 wt % of the graphene sheets, and thoroughly ball milled to form the anode slurry for the anode material. Then, the cathode slurry and the anode slurry are coated onto the cathode current collector and the anode current collector, respectively, and dried in the vacuum oven to form the cathode active layer and the anode active layer. The separator is sandwiched between the cathode active layer and the anode active layer so as to form the graphene-containing electrochemical device. Substantially, the first metal foil substrate and the first graphene conductive layer are configured in reverse order with respect to the arrangement of the second metal foil substrate and the second graphene conductive layer. The electrolyte is injected into the graphene-containing electrochemical device to form a simple capacitor device, which is advantageous over the traditional capacitor because of the impedance being reduced by about 75%.

### Example 3

The graphene sheets are placed into N-methyl pyrrolidinone (NMP) as a solvent, and then PVDF (polyvinylidene fluoride) as the polymer binder is added and mixed to form a primitive slurry, which is ground by a ball mill for hours to form the graphene slurry. The graphene slurry is sprayed on the metal aluminum foil and dried to evaporate NMP so as to form the cathode/anode current collectors. Next, lithium iron phosphate with 85% of the graphene sheets, 7 wt % of the conductive graphite, 3.75 wt % of the binder and 4.25 wt % of the NMP solvent are ball milled to form the cathode slurry for the cathode material. 80 wt % of the active carbon, 10 wt % of graphene, and 10 wt % of the binder are mixed with the NMP solvent and ball milled to form the anode slurry for the anode material. Next, the cathode slurry and the anode slurry are coated onto the cathode current collector and the anode current collector, respectively, and dried in the vacuum oven to form the cathode active layer and the anode active layer. The separator is sandwiched between the cathode active layer and the anode active layer so as to form the graphene-containing electrochemical device, which is injected with the electrolyte to construct a simple capacitor device.

From the above-mentioned, one aspect of the present invention is that with the graphene added to the graphene-containing electrochemical device, the conductivity of the cathode/anode active particles is not only increased, but the compatibility between the cathode/anode active material and the metal foil substrate is also increased and the junction resistance is reduced because the current collector has the graphene layer. As a result, an integrated conductive network is formed, and the performance of the elements of the electrochemical device is greatly improved.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A graphene-containing electrochemical device, comprising:
a cathode current collector comprising a first metal foil substrate and a first graphene conductive layer stacked on the first metal foil substrate, the first graphene conductive layer comprising a plurality of first graphene sheets and a first polymer binder binding the first graphene sheets onto a surface of the first metal foil substrate;
an anode current collector comprising a second metal foil substrate and a second graphene conductive layer stacked on the second metal foil substrate, the second graphene conductive layer comprising a plurality of second graphene sheets and a second polymer binder binding the second graphene sheets onto a surface of the second metal foil substrate, wherein the surface of the anode current collector on which the second graphene conductive layer is formed faces the surface of the cathode current collector on which the first graphene conductive layer is formed;
a cathode active layer formed on the first graphene conductive layer, comprising a plurality of third graphene sheets and a plurality of cathode active particles, wherein the third graphene sheets and the cathode active particles are bound and adhered onto the first graphene conductive layer by the first polymer binder while the third graphene sheets are blended among the cathode active particles;
an anode active layer formed on the second graphene conductive layer, comprising a plurality of fourth graphene sheets and a plurality of anode active particles, wherein the fourth graphene sheets and the cathode active particle are bound and adhered onto the second graphene conductive layer by the second polymer binder while the fourth graphene sheets are blended among the anode active particles; and
a separator provided between the cathode active layer and the anode active layer, wherein each of the first, second, third and fourth graphene sheets has a thickness of 1˜50 nm and a planar lateral dimension of 1 μm˜50 μm.

2. The graphene-containing electrochemical device as claimed in claim 1, wherein each of the first graphene conductive layer and the second graphene conductive layer has a thickness less than 5 μm.

3. The graphene-containing electrochemical device as claimed in claim 1, wherein the first metal foil substrate and the second metal foil substrate are metal foils made of at least one of aluminum, copper, titanium, nickel, cobalt, manganese and stainless steel.

4. The graphene-containing electrochemical device as claimed in claim 1, wherein the first polymer binder and/or the second polymer binder is selected from a group comprising at least one of polyvinylidene fluoride, polyethylene terephthalate, polyurethane, polyethylene oxide, polyacrylonitrile, polyacrylamide, poly(methyl acrylate), polymethyl methacrylate, polyvinyl acetate, polyvinyl pyrrolidone, polytetraglycol Diacrylate, polyimide, cellulose acetate, cellulose acetate butyrate, cellulose acetate propionate, ethyl cellulose ethoce, cyano ethyl cellulose, cyano ethyl polyvinyl alcohol and carboxy methyl cellulose, and shows a colloidal state in contact with an electrolyte.

5. The graphene-containing electrochemical device as claimed in claim 4, wherein the first polymer binder and/or the second polymer binder further comprises at least one of a thermosetting resin and a photo-setting resin.

6. The graphene-containing electrochemical device as claimed in claim 5, wherein the thermosetting resin or the photo-setting resin comprises at least one of epoxy resin and phenolic resin.

7. The graphene-containing electrochemical device as claimed in claim 1, wherein the cathode active particles are a lithium metal compound, a metal oxide or active carbon, and the third graphene sheets is less than 10 wt % with respect to the cathode active particles.

8. The graphene-containing electrochemical device as claimed in claim 7, wherein the metal oxide comprises at least one of manganese oxide and ruthenium oxide.

9. The graphene-containing electrochemical device as claimed in claim 1, wherein the anode active particles are at least one of graphite, mesocarbon microbead (MCMB), silicon, tin oxide, and active carbon, and the fourth graphene sheets is less than 50 wt % with respect to the anode active particles.

10. The graphene-containing electrochemical device as claimed in claim 1, wherein the separator comprises at least one of polyethylene, polypropylene, nonwoven fabric and specific paper.

11. The graphene-containing electrochemical device as claimed in claim 1, wherein the first polymer binder spills among the first graphene conductive layer and the cathode active layer, and the second polymer binder spills among the second first graphene conductive layer and the anode active layer.

12. The graphene-containing electrochemical device as claimed in claim 1, wherein the first polymer binder is further provided on a surface of the first graphene conductive layer such that the first graphene conductive layer and the cathode active layer are adhered together, and the second polymer binder is further provided on a surface of the second graphene conductive layer such that the second graphene conductive layer and the anode active layer are adhered together.
